(19) United States
(12) Patent Application Publication
(10) Pub. No.: US 2012/0259440 A1
(43) Pub. Date: Oct. 11, 2012

(54) METHOD FOR MANAGING CONFLICTS BETWEEN AUDIO APPLICATIONS AND CONFLICT MANAGING DEVICE

(76) Inventor: Yehui Zhang, Shanghai (CN)

(21) Appl. No.: 13/391,783

(22) PCT Filed: Dec. 27, 2010
(86) PCT No.: PCT/CN2010/080291

§ 371 Date: Feb. 22, 2012

(30) Foreign Application Priority Data
Dec. 31, 2009 (CN) 200910247974.9

(51) Int. Cl. G06F 17/00

(52) U.S. Cl. 700/94

(57) ABSTRACT

The present invention provides a method for managing conflicts between audio applications and a conflict managing device for the audio applications, the method includes: Acquiring state information of audio applications; determining a processing strategy for the audio applications based on an arbitration strategy when conflicts happen between the audio applications; and adjusting states of the audio applications according to the processing strategy. And the method can automatically adjust states of the audio applications based on the arbitration strategy when conflicts happen between the audio applications, so as to avoid poor audio and visual effects caused by the conflicts.

### CROSS REFERENCE TO RELATED APPLICATIONS

The present application claims the priority of Chinese Patent Application No. 200910247974.9, entitled “Method for Managing Conflicts between Audio Applications and Conflict Managing Device”, and filed on Dec. 31, 2009, the entire disclosure of which is incorporated herein by reference.

### FIELD OF THE INVENTION

The present invention generally relates to a method for managing conflicts between audio applications and a conflict managing device for the audio applications.

### BACKGROUND OF THE INVENTION

With development of the multi-media information technology, an integrated application system generally includes several sounder units and several audio applications for meeting needs of users in all aspects. Taking a vehicle-mounted system in an automobile as an example, the vehicle-mounted system generally includes several audio applications such as an FM radio, a GPS audio navigation system and an on-vehicle phone, each of which is corresponding to a respective sounder unit.

Because the audio applications are independent to each other and are corresponding to different sounder units, conflicts may happen between the audio applications. For example, while listening to the FM radio or using the GPS audio navigation system, a driver receives a call through the on-vehicle phone, but the driver can not adjust the ongoing audio applications of the FM radio and the GPS audio navigation system because he or she is driving, so that the call quality will be adversely influenced. Furthermore, the more audio applications are configured in the vehicle-mounted system, the higher possibility of the conflicts between audio applications is. Therefore, several sounder units working together may causes poor audio and visual effects. In prior art, generally, the audio applications are managed separately, but the conflicts between the audio applications corresponding to different sounder units are hardly to be controlled, and the states of the audio applications can not be adjusted automatically according to the conflicts.

In a Chinese Patent application with an application number NO. 2008.10099301.9, a method for managing audio applications is disclosed.

### SUMMARY OF THE INVENTION

Embodiment of the present invention provide a method for managing conflicts between audio applications and a conflict managing device for audio applications, so as to automatically adjust states of the audio applications when conflicts happen between the audio applications.

In order to solve the above problem, the embodiments of the present invention provide a method for managing conflicts between audio applications, including: Acquiring state information of audio applications; determining a processing strategy for the audio applications based on an arbitration strategy when conflicts happen between the audio applications; and adjusting states of the audio applications according to the processing strategy.

Optionally, the step of acquiring the state information of the audio applications includes: Acquiring state information of audio applications in use and state information of newly added audio applications.

Optionally, the newly added audio applications and the audio applications being processed are corresponding to different sounder units.

Optionally, the step of determining a processing strategy according to a play request for the audio applications based on the arbitration strategy includes:

Determining a scenario according to the state information of the audio applications based on the arbitration strategy; and determining the processing strategy according to the scenario corresponding to the audio applications.

Optionally, the step of determining the processing strategy for the audio applications based on the arbitration strategy includes: Ranking the audio applications according to priorities of the audio applications based on the arbitration strategy; and determining the processing strategy according to the ranking result of the audio applications.

Optionally, determining the processing strategy includes: Determining volumes of the sounder units or determining the sounder units mute or not.

Optionally, the arbitration strategy is recorded in a strategy file.

Optionally, the strategy file is in a XML format.

The embodiments of the present invention further provide a conflict managing device for audio applications, including:

An audio application detector, adapted for acquiring state information of audio applications;

A strategy arbiter, adapted for determining a processing strategy when conflicts happen between audio applications; and

An audio application controller, adapted for adjusting states of the audio applications according to the processing strategy based on an arbitration strategy.

Optionally, the audio application detector includes:

A state information storage unit, adapted for recording state information of audio applications in use; and

A state information receiving unit, adapted for receiving state information of newly added audio applications.

Optionally, the newly added audio applications and the audio applications in use are corresponding to different sounder units.

Optionally, the strategy arbiter includes:

A scenario determining unit, adapted for determining a scenario according to the state information of the audio applications based on an arbitration strategy; and

A processing strategy determining unit, adapted for determining the processing strategy for the audio applications according to the scenario.

Optionally, the arbiter includes:

An audio application ranking unit, adapted for ranking the audio applications according to priorities of the audio applications based on the arbitration strategy; and

A processing strategy determining unit, adapted for determining the processing strategy for the audio applications according to the ranking result.

Optionally, the audio application controller includes: A sounder unit controller, adapted for determining volumes of the sounder units or determining the sounder units mute or not.

Optionally, the arbitration strategy is recorded in a strategy file.

Optionally, the strategy file is in a XML format.

Optionally, the audio application detector and the audio application controller are integrated in a sound application management device.

Compared with the prior art, the embodiments of the present invention have the following advantages.

In the embodiments of the present invention, the method for managing conflicts between audio applications can detect state information of the audio applications, and automatically adjust the states of the audio applications based on the arbitration strategy when conflicts happen between the audio applications, so as to avoid poor audio visual effects caused by corresponding sounder units of the audio application working together at the same time.

### BRIEF DESCRIPTION OF THE DRAWINGS

FIG. 1 is a flow chart for illustrating a method for managing conflicts between audio applications in an embodiment of the present invention;

FIG. 2 is a schematic view for showing an arbitration strategy in a first embodiment of the present invention;

FIG. 3 is a schematic view for showing an arbitration strategy in a second embodiment of the present invention; and

FIG. 4 is a schematic view for showing a structure of a conflict managing device for audio applications in an embodiment of the present invention.

### DETAILED DESCRIPTION OF THE EMBODIMENTS

In order to provide a thorough understanding of the above-mentioned and other objectives, features and advantages of the present invention, embodiments of the present invention will be described hereinafter in conjunction with the attached drawings.

The embodiments are described herein just for illustrative purposes, and are not intended to limit the scope of the present invention. It shall be appreciated by those skilled in the art that alternative ways may be made without deviation from the scope of the invention. Therefore the invention is not limited within the embodiments described here.

In a conventional integrated system, audio applications are managed separately, several corresponding sounder units may work at the same time and conflicts may happen between the audio applications, which may cause poor audio and visual effects.

A method for managing conflicts between audio applications provided in embodiments of the present invention detects state information of the audio applications. If conflicts happen between the audio applications, a processing strategy will be determined based on an arbitration strategy, and states of the audio applications will be adjusted automatically according to the processing strategy, so as to avoid poor audio and visual effects caused by the conflicts.

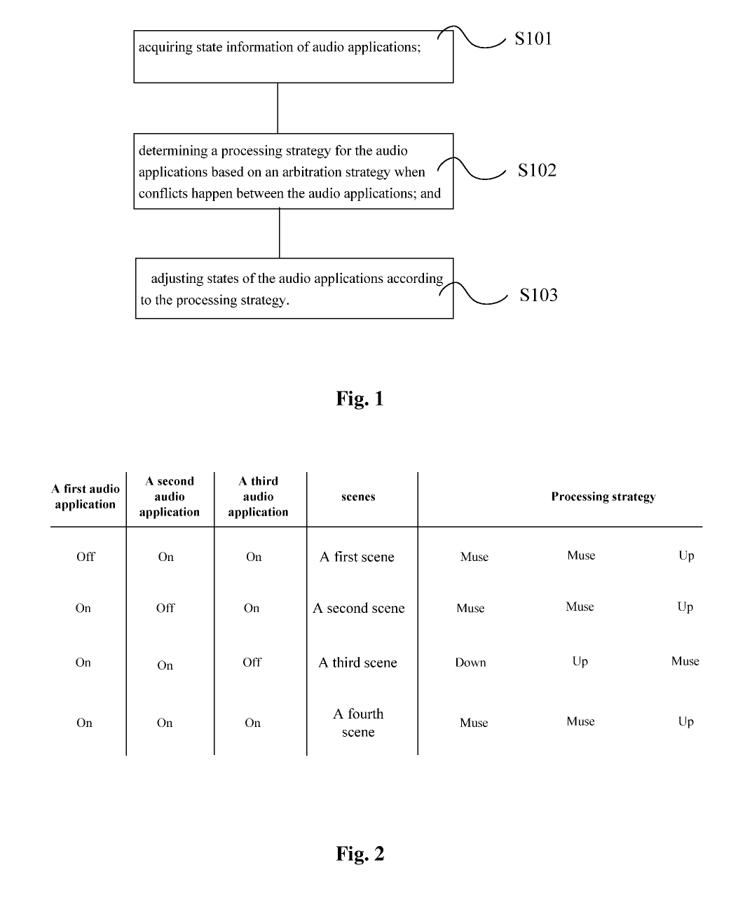

FIG. 1 is a flow chart for illustrating a method for managing conflicts between audio applications in an embodiment of the present invention. Referring to FIG. 1, the method includes:

Step S101, acquiring state information of audio applications;

Step S102, determining a processing strategy for the audio applications based on an arbitration strategy when conflicts happen between the audio applications; and

Step S103, adjusting states of the audio applications according to the processing strategy.

In S101, the state information includes state information of the audio applications such as on/off states, and volumes of the audio applications. The step of acquiring the state information of the audio applications includes: Acquiring state information of audio applications in use and newly added audio applications. In an embodiment, the audio applications in use maybe an FM radio being played, and a GPS audio navigation system in use. And the newly added audio applications may be a call received by an on-vehicle phone. In addition, the audio applications being used and the newly added audio applications respectively are corresponding to different sounder units. In the embodiment, a sounder unit of the FM radio is corresponding to a radio trumpet, a sounder unit of the GPS audio navigation system is corresponding to a sounder of the GPS system, and a sounder unit of the on-vehicle phone is corresponding to a receiver of the on-vehicle phone.

In the above embodiment of the present of invention, the corresponding sounder units of the three audio applications (the FM radio, the GPS audio navigation system and the on-vehicle phone) work together at the same time, which may cause conflicts between the audio applications, thereby causing poor audio and visual effects. In S102, the step of determining a processing strategy for the audio applications based on an arbitration strategy includes: Determining a scenario of the audio applications according to the state information based on the arbitration strategy; and determining the processing strategy according to the scenario of the audio applications. In an embodiment, the arbitration strategy is recorded in a strategy file in an XML format, and the XML file may be amended according to practical requirements. For example, the XML file will be amended if a new audio application is added, a new scenario needs to be added or the processing strategy needs to be amended according to the new scenario.

FIG. 2 is a schematic view for showing an arbitration strategy in a first embodiment of the present invention. The arbitration strategy includes state information of audio applications. Specifically, Referring to FIG. 2, there are three audio applications including a first audio application, a second audio application and a third application. In an embodiment, the first audio application is corresponding to an FM radio, the second audio application is corresponding to a GPS audio navigation and the second audio application is corresponding to an on-vehicle phone. Referring to FIG. 2, the arbitration strategy includes state information such as on/off states, that is, an audio application being in a working state or a standby state. In another embodiment, the state information further includes volumes of the audio applications in use. Referring to FIG. 2, the arbitration strategy further includes scenarios corresponding to the audio applications, namely a first scenario, a second scenario, a third scenario and a fourth scenario. Moreover, the arbitration strategy also includes different processing strategies corresponding to each different scenario, and the processing strategies determine volumes of corresponding sounder units or determine the sounder units mute or not. Referring to FIG. 2, ‘Up’ indicates turning up the volume, ‘Down’ indicates turning down the volume, and ‘Muse’ indicates being mute. In an embodiment, the first audio application is corresponding to an FM radio and the second audio application is corresponding to a GPS audio navigation system and both of them are in use, which is corresponding to the third scenario. The third audio application is corresponding to an on-vehicle phone which is a newly added audio application. By combining the state information of the newly added audio application and the first and second audio applications in use, the current state information of the three audio applications is corresponding to the fourth scenario. Thereafter, a processing strategy is determined according to the fourth scenario, which includes adjusting the volumes of the audio applications or making some of them mute. In the embodiment, after the adjustment, the FM radio and the GPS audio navigation system are mute, and the on-vehicle phone works normally.

Referring to FIG. 1, in a second embodiment, in S102, the step of determining a processing strategy for the audio applications based on another arbitration strategy includes: Ranking the audio applications according to priorities of the audio applications based on the arbitration strategy; and determining a processing strategy according to the ranking result of the audio applications. In an embodiment, the arbitration strategy is recorded in a strategy file in an XML format, and the XML file may be amended according to practical requirements. For example, the XML file is amended if a new audio application is added, a new scenario needs to be added or the processing strategy needs to be amended according to the new scenario.

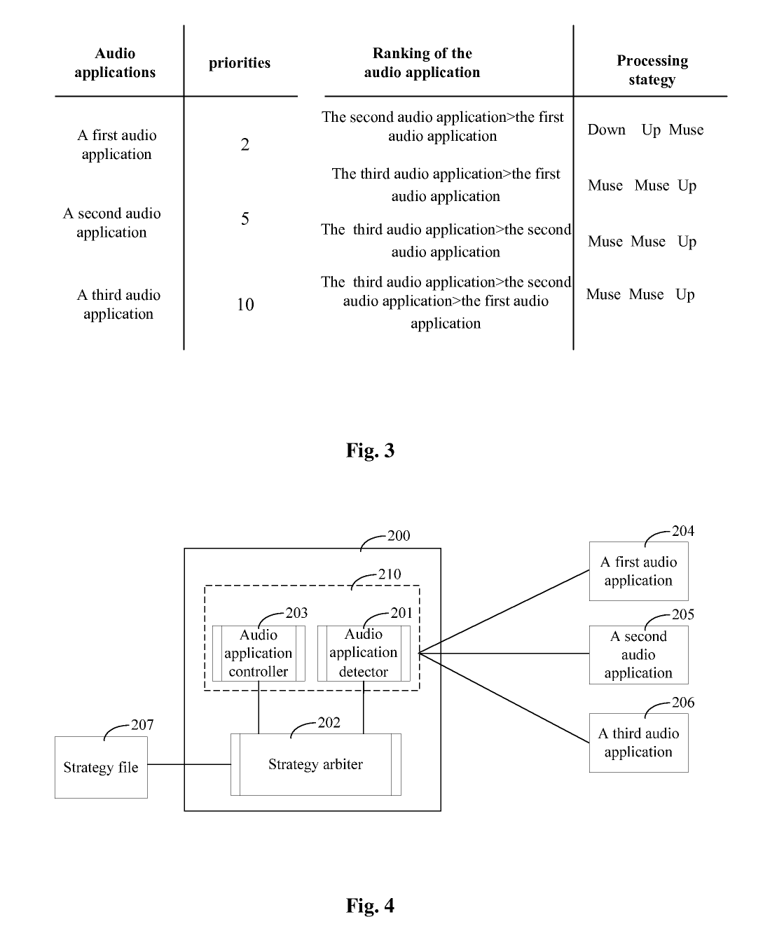

FIG. 3 is a schematic view for illustrating the arbitration strategy in the second embodiment of the present invention. Referring to FIG. 3, the arbitration strategy includes priorities of the audio applications and a processing strategy determined according to the ranking result of the priorities of the audio applications. In an embodiment, a priority of the first audio application is 2, a priority of the second audio application is 5, and a priority of the third audio application is 10. In other words, the FM radio has a low priority, the GPS audio navigation system has a middle priority and the on-vehicle phone has a high priority. After obtaining the priorities of the audio applications according to the state information, the audio applications are ranked according to the priorities of the audio applications. In the embodiment, if all of the three audio applications are in a working state, then the result of ranking the audio applications in the order of priorities from high to low is: the third audio application, the second audio application and the first audio application. And then the processing strategy is determined according to the ranking result, including: the FM radio and the GPS audio navigation system being mute, and the on-vehicle phone working normally.

Referring to FIG. 1, S103 is performed, in which the states of the audio applications are adjusted. In an embodiment, the adjustment includes: Configuring the FM radio and the GPS audio navigation system mute; and keeping the on-vehicle phone working normally, which can makes sure the communication process of the on-vehicle phone is not adversely influenced by the other two audio applications.

It should be noted that, after the call received by the on-vehicle phone is over, the on-vehicle phone returns to be in a standby state, the state information of the on-vehicle phone is changed, and the steps S101 to S103 will be performed again. Specifically, the states of the audio applications will be readjusted according to the current state information of the audio applications based on the arbitration strategy. In the embodiment, the FM radio and the GPS audio navigation system are configured to work normally again after the readjusting process.

FIG. 4 is a schematic view for showing a structure of a conflict managing device for audio applications in an embodiment of the present invention. The device includes: An audio application detector 201, a strategy arbiter 202, and an audio application controller 203.

The audio application detector 201 is adapted for acquiring the state information of the audio applications. In an embodiment, the state information includes state information of a first audio application 204, a second audio application 205 and a third audio application 206, specifically, the state information of the FM radio, the GPS audio navigation system and the on-vehicle phone which respectively correspond to different sounder units. The audio application detector 201 includes a state information storage unit and a state information receiving unit. The state information storage unit is adapted for recording the state information of the audio applications in use. In the embodiment, the state information storage unit is adapted for recording the state information of the FM radio and the GPS audio navigation system. The state information receiving unit is adapted for receiving the state information of the newly added audio applications. In the embodiment, the state information receiving unit is adapted for receiving the state information of the on-vehicle phone.

The strategy arbiter 202 is adapted for determining the processing strategy based on the arbitration strategy when conflicts happen between audio applications. In an embodiment, information about conflicts is acquired by the audio application detector 201 when conflicts happen between the FM radio and the GPS audio navigation system. In the embodiment, the strategy arbiter 202 includes: A scenario determining unit, adapted for determining a scenario according to the state information of the audio applications based on the arbitration strategy; and a processing strategy determining unit, adapted for determining a processing strategy for the audio applications according to the scenario. In the embodiment, the arbitration strategy is recorded in the strategy file 207 in the XML format which is shown in FIG. 2 and will not be described in detail herein. In the embodiment, there is a fourth scenario which is the same as that in the FIG. 2, and a same processing strategy is determined according to the fourth scenario, including: The FM radio and the GPS audio navigation system being mute, and the on-vehicle phone working normally.

In another embodiment, the strategy arbiter 202 includes: An audio application ranking unit, adapted for ranking the audio applications according to the priorities of the audio applications based on the arbitration strategy; and a processing strategy determining unit, adapted for determining a processing strategy for the audio applications according to the ranking result. In the embodiment, the arbitration strategy is recorded in the strategy file 207 in the XML format which is shown in FIG. 3 and will not be described in detail herein, the ranking result is the same as that described in FIG. 3: the third audio application, the second audio application and the first audio application, and the processing strategy includes: The FM radio and the GPS audio navigation system being mute and the on-vehicle phone working normally.

The audio application controller 203 includes a sounder unit controller which is adapted for determining volumes of the corresponding sounder units or determining the sounder units mute or not. In an embodiment, the audio application controller 203 is adapted for making the FM radio and the GPS audio navigation system mute and the on-vehicle phone work normally.

In an embodiment, the audio application detector 201 and the audio application controller 203 are integrated in a sound application management device 210, which increases the integration density of the device.

In an embodiment, the conflicts managing device 200 is achieved based on software. In other embodiments, the conflicts managing device 200 also may be achieved based on an embedded system with combination of hardware circuits and software. If conflicts happen, the conflicts managing device 200 may adjust the states of the audio applications.

The method for managing conflicts between audio applications provided in the embodiments of the present invention can determine the processing strategy based on the arbitration strategy, and adjust the states of the audio applications according to the processing strategy when conflicts happen between the audio applications, so as to avoid the poor audio and visual effects caused by the conflicts.

Although the present invention has been disclosed as above with reference to preferred embodiments, it is not intended to limit the present invention. Those skilled in the art may modify and vary the embodiments without departing from the spirit and scope of the present invention. Accordingly, the scope of the present invention shall be defined in the appended claim.

1. A method for managing conflicts between audio applications, comprising:
acquiring state information of audio applications;
determining a processing strategy for the audio applications based on an arbitration strategy when conflicts happen between the audio applications; and
adjusting states of the audio applications according to the processing strategy.

2. The method according to claim 1, wherein
the step of acquiring the state information of the audio applications comprises: acquiring state information of audio applications in use and state information of newly added audio applications.

3. The method according to claim 2, wherein the newly added audio applications and the audio applications being processed are corresponding to different sounder units.

4. The method according to claim 1, wherein the step of determining a processing strategy according to a play request for the audio applications based on the arbitration strategy comprises:
determining a scenario according to the state information of the audio applications based on the arbitration strategy; and
determining the processing strategy according to the scenario corresponding to the audio applications.

5. The method according to claim 1, wherein the step of determining the processing strategy for the audio applications based on the arbitration strategy comprises:
ranking the audio applications according to priorities of the audio applications based on the arbitration strategy; and
determining the processing strategy according to the ranking result of the audio applications.

6. The method according to claim 1, wherein the step of determining the processing strategy comprises: determining volumes of the sounder units or determining the sounder units mute or not.

7. The method according to claim 1, wherein the arbitration strategy is recorded in a strategy file.

8. The method according to claim 7, wherein the strategy file is in a XML format.

9. A conflict managing device for audio applications, comprising:
an audio application detector, adapted for acquiring state information of audio applications;
a strategy arbiter, adapted for determining a processing strategy when conflicts happen between the audio applications; and
an audio application controller, adapted for adjusting states of the audio applications according to the processing strategy based on an arbitration strategy.

10. The device according to claim 9, wherein the audio application detector comprises:
a state information storage unit, adapted for recording state information of the audio applications in use; and
a state information receiving unit, adapted for receiving state information of newly added audio applications.

11. The device according to claim 10, wherein the newly added audio applications and the audio applications in use are corresponding to different sounder units.

12. The device according to claim 9, wherein the strategy arbiter comprises:
a scenario determining unit, adapted for determining a scenario according to the state information of the audio applications based on an arbitration strategy; and
a processing strategy determining unit, adapted for determining the processing strategy for the audio applications according to the scenario.

13. The device according to claim 9, wherein the arbiter comprises:
an audio application ranking unit, adapted for ranking the audio applications according to priorities of the audio applications based on the arbitration strategy; and
a processing strategy determining unit, adapted for determining the processing strategy for the audio applications according to the ranking result.

14. The device according to claim 9, wherein the audio application controller comprises: a sounder unit controller, adapted for determining volumes of the sounder units or determining the sounder units mute or not.

15. The device according to claim 9, wherein the arbitration strategy is recorded in a strategy file.

16. The device according to claim 15, wherein the strategy file is in a XML format.

17. The device according to claim 9, wherein the audio application detector and the audio application controller are integrated in a sound application management device.
